(19) United States
(12) Patent Application Publication
(10) Pub. No.: US 2026/0168800 A1
(43) Pub. Date: Jun. 18, 2026

(54) CONTROLLING A DEVICE TO SENSE AN ENVIRONMENT AROUND THE DEVICE

(71) Applicant: Telefonaktiebolaget LM Ericsson (publ), Stockholm (SE)

(72) Inventors: Maxime BOUTON, Stockholm (SE); Carmen LEE ALTMANN, Täby (SE); Hossein SHOKRI GHADIKOLAEI, Täby (SE); Anders BERKEMAN, LUND (SE); Leif WILHELMSSON, LUND (SE); Pontus ARVIDSON, SOLLENTUNA (SE)

(21) Appl. No.: 19/125,868

(22) PCT Filed: Nov. 9, 2022
(86) PCT No.: PCT/SE2022/051041

§ 371 Date: Apr. 30, 2025

(51) Int. Cl. G01C 21/34; G01S 5/02; G01S 15/00; G01S 17/00

(52) U.S. Cl. CPC G01C 21/3453; G01S 5/02521; G01S 15/00; G01S 17/00

(57) ABSTRACT

There is provided a computer-implemented method of controlling a device. The method comprises sensing an environment in which the device is located using radio frequency, RF, signals received by the device; and determining, based on the received RF signals, whether to use one or more further environment sensors to further sense the environment around the device.

### TECHNICAL FIELD

This disclosure relates to a device, for example an autonomous device, and in particular to the sensing of an environment around the device using radio frequency (RF) signals.

### BACKGROUND

Autonomous devices, which can be in the form of mobile robots, are being used for a variety of industrial applications including warehouse storage, office space cleaning and maintenance, and monitoring of infrastructure. These robots can be either ground vehicles or unmanned aerial vehicles (UAV), and are powered by batteries and operating under limited energy resources. To be able to accomplish their tasks, robots must be able to efficiently navigate the environment in which they operate. They are often equipped with a variety of perception sensors and have access to high-definition maps of the environment. Cameras coupled with object detection algorithms allow for very accurate vision-based navigation. They are also useful for monitoring tasks to detect features of the environment. However, these sensing modalities have two major setbacks: they are very energy-hungry which reduces the range of robots, and they are sensitive to occlusions. Occlusions refers to objects or areas that are not visible to the camera(s) on the robot, for example a moving person hidden from view by a corner of a building.

Energy saving can be achieved by finding the optimal algorithms for path finding/planning or through selecting more efficient techniques and hardware that are suitable for a particular purpose. Setting up a mesh network or making use of an existing one while using passive sensors as opposed to active sensors such as LIDAR (Laser Imaging, Detection and Ranging) or cameras, is a common practice to reduce energy consumption.

Sensitivity to occlusions is a challenge for many robotic applications as the robot must be aware of the uncertainty to safely navigate. Designing navigation strategies that are not overly conservative in those situations is very challenging.

Radio sensing has been standardised for both mobile networks and Wi-Fi networks. Radio waves can be used in a principled way to detect changes in the environment and even be used for localisation or tracking moving objects. This is described in “Autonomous Wi-Fi fingerprinting for indoor localization” by Shilong Dai et al., 2020 ACM/IEEE 11^{th} International Conference on Cyber-Physical Systems (ICCPS) [Reference 1], and in a blog “Joint communication and sensing in 6G networks” by Håkan Andersson Y (https://www.ericsson.com/en/blog/2021/10/joint-sensing-and-communication-6g) [Reference 2]. Radio waves can be used by robots to perform sensing and localisation using techniques such as fingerprinting or multilateration, as described in Reference 1. Outside of robotic applications, radio sensing technologies can be used for monitoring purposes in indoor environments. A key feature of radio-based sensing is that it can detect entities that are not in line-of-sight. Detection can be performed through obstacles that are permeable to the radio frequency being used but also thanks to the fact that a mesh of different emitter and transceiver is available.

Application of Wi-Fi or radio sensing to motion detection has been commercialised and well-studied, for example in Reference 1 and in “Decimeter-Level Localization with a Single WiFi Access Point” by Vasisht, Deepak, Swarun Kumar, and Dina Katabi, 13^{th} USENIX Symposium on Networked Systems Design and Implementation (NSDI 16), pp. 165-178. 2016 [Reference 3]. Measurements from heterogeneous sensors are sometimes combined (known as multi-sensor fusion) to improve performance when high accuracy and high performance are most critical, e.g. as described in “Indoor navigation: State of the art and future trends” by El-Sheimy, Naser, and You Li, Satellite Navigation 2, no. 1 (2021): 1-23 [Reference 4]. This multi-sensor fusion is at the expense of high energy demand and short battery life.

Wi-Fi sensing has been applied to robot indoor localisation, as described in Reference 1, and high level localisation accuracy can even be achieved using one single Wi-Fi access point equipped with multiple antennas, as described in Reference 3.

However, further improvements are desired in navigation and mission (route) planning for autonomous devices/vehicles.

### SUMMARY

Thus, this disclosure addresses the problem of navigation and mission planning using multiple sensing modalities. While some proposals exist that use Wi-Fi for detecting occluded targets in navigation problems, for example “Wi-Fi-based obstacle detection for robot navigation” by Dina Katabi (https://toyota.csail.mit.edu/node/39) [Reference 5], Wi-Fi sensing is not currently used to detect occluded obstacles and perform more efficient navigation in a principled way.

Two use cases that can be addressed by the techniques described herein are described below.

A first use case is a UAV that is monitoring a mobile network base station. The UAV can be equipped with cameras and an image processing module that is capable of obstacle detection that informs the navigation and control module. Since the environment is expected to be static, at a given location, the radio signal should be the same most of the time. The UAV can navigate without using its cameras (but still using other sensing capabilities like Inertial Measurement Units (IMUs)), and use Wi-Fi to monitor whether something has changed in the environment. If a change is detected, then the camera can be turned on (or processing of the camera images activated) for better navigation. Such an approach leads to significant energy savings and result in a longer range for the UAV and/or a longer time between recharging operations. The techniques in Reference [1] do not consider the use of other sensors, and instead suggests visiting the area and increasing the number of Wi-Fi measurements to refine the knowledge about the environment. In some cases, it might be dangerous if the robot visits the area as a change in the radio signal might be due to an obstacle. Being able to toggle (selectively activate) other sensor modalities in that case could resolve the ambiguity. Using two sensors extends the range of the UAV while keeping the navigation safe.

A second use case fronthaul interfaces for a robot to use radio sensing to detect occluded obstacles. In the case of indoor navigation, the use of Wi-Fi sensing can inform the robot of the presence and motion of obstacles along its course (possibly outside its line-of-sight), and thus inform the planner to take another path. Measuring this type of information with LIDAR or cameras would be energy-hungry, short range, and sensitive to occlusions, whereas by using Wi-Fi, the robot could be informed on the presence of obstacles in different rooms and plan in advance for a new route, should it be necessary.

In the conventional systems referenced above, radio sensing applications use Wi-Fi. However, the techniques described herein can also or alternatively make use of a 5^{th} Generation (5G) or a 6^{th} Generation (6G) 3^{rd} Generation Partnership Project (3GPP) standardised network, for outdoor scenarios for example.

Thus, this disclosure proposes a new way to combine radio sensing with other sensors such that the use of energy-hungry sensors can be reduced or optimised.

The techniques described herein use radio sensing to improve autonomous device navigation in multiple ways. First, an adaptive sensing technique is proposed in which energy-hungry sensors are only used when a change in the environment is detected by the radio sensor. In this context, the robot can navigate by only measuring the radio (e.g. Wi-Fi) signal, along with its previous maps, for most of the time using fingerprinting techniques, and trigger image-based navigation (and consequently a map update) if the environment is different from what is expected. Second, the planning capabilities of the autonomous device can be enhanced by observing obstacles, such as a human presence in non-line of sight areas, using radio sensing and dynamically updating a cost graph that can be used by the autonomous device planning module.

Some embodiments of the techniques described herein can provide a method for performing wireless sensing (i.e. sensing using RF signals). In this method, the sensing may be complemented by other sensing modalities that do not use RF. The obtaining of the complementary sensing data can be triggered by the obtained wireless sensing data. The wireless/radio sensing can be based on Wi-Fi. The wireless/radio sensing can be based on passive sensing. In these embodiments, the passive sensing may use broadcast signals sent out by an Access Point (AP) or base station (e.g. an eNB or gNB). The broadcast signal can be a beacon signal, for example as sent out by an IEEE 802.11 AP.

In some embodiments, the triggering can occur when it is expected that the wireless sensing will not achieve the required sensing performance, i.e. a required sensing accuracy. The complementary sensing may be based on using a camera or other non-RF based, or other line-of-sight based, sensors. In some embodiments, triggering the complementary sensor means taking a single sensing measurement using the complementary sensor. In alternative embodiments, triggering the complementary sensor means turning the complementary sensor on for a predetermined period of time. In yet further alternative embodiments, triggering the complementary sensor means turning the complementary sensor on to collect a predetermined number of sensor measurements.

Some embodiments of the techniques described herein can provide a method for building a cost map from the wireless sensing result, including any obstacles that are out of line-of-sight. This cost map can be further used by a planning algorithm, for example for planning autonomous device navigation tasks.

Some embodiments and aspects of the techniques described herein can reduce energy consumption through, among other things, adapting the frequency (i.e. how often) energy-hungry sensors are used. As a result, autonomous devices can navigate for longer periods of time without needing to recharge. In the case of autonomous devices where the device is static, energy savings are still desirable, and obtainable when using the techniques described herein.

Sensing using Wi-Fi can be active or passive. Active sensing sends Wi-Fi packets dedicated to sensing, while passive sensing appends sensing data to existing Wi-Fi traffic. A passive design can further reduce energy consumption. A particularly advantageous approach for passive sensing is to make use of the beacon signals that are sent on regular intervals from an AP (say, for example, every 100 milliseconds (ms).

Through the ability of radio (RF) sensing to detect occluded obstacles, the autonomous device can plan and avoid crowded areas (if required by the task being performed), or visit areas where a change in monitoring tasks is expected.

According to a first aspect, there is provided a computer-implemented method of controlling a device. The method comprises sensing an environment in which the device is located using radio frequency, RF, signals received by the device; and determining, based on the received RF signals, whether to use one or more further environment sensors to further sense the environment around the device.

According to a second aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a third aspect, there is provided an apparatus configured to control a device. The apparatus is configured to: sense an environment in which the device is located using radio frequency, RF, signals received by the device; and determine, based on the received RF signals, whether to use one or more further environment sensors to further sense the environment around the device.

According to a fourth aspect, there is provided an apparatus configured to control a device. The apparatus comprises a processor and a memory, said memory containing instructions executable by said processor whereby said apparatus is operative to: sense an environment in which the device is located using radio frequency, RF, signals received by the device; and determine, based on the received RF signals, whether to use one or more further environment sensors to further sense the environment around the device.

### BRIEF DESCRIPTION OF THE DRAWINGS

Some of the embodiments contemplated herein will now be described more fully with reference to the accompanying drawings, in which:

FIG. 1 shows a device according to embodiments of the techniques described herein;

FIG. 2 is a block diagram illustrating collected data and training procedure of a model that provides or is an encoded representation of a RF signal map;

FIGS. 3(a), (b) and (c) illustrate mono-static and multi-static sensing;

FIGS. 4(a) and (b) illustrate the updating of a cost map after RF signal sensing of an obstacle in an adjacent room;

FIG. 5 is a flow chart illustrating a method of controlling a device according to various embodiments; and

FIG. 6 is a block diagram of an apparatus according to embodiments of the techniques described herein.

### DETAILED DESCRIPTION

The techniques described herein can be summarised as an augmentation of the regular autonomy stack of an autonomous device using adaptive radio frequency (RF) sensing. For indoor use of an autonomous device, Wi-Fi is considered, and for outdoor use of an autonomous device, mobile network signals are applicable. Naturally, different standards are applicable for both indoor and outdoor use, but using Wi-Fi for indoors, and mobile networks for outdoors, is seen as the preferred approach, although the techniques described herein are not limited to this. In this disclosure the terminology “radio sensing” is used to refer to the sensing of an environment in which the autonomous device is located using RF signals. Embodiments of the techniques described herein can use two main modules or algorithms for processing or analysing the radio sensing input. The first module or algorithm is a sensor activation module that is responsible for the selective activation of a further environment sensor (also referred to herein as “further sensor”), such as an energy-hungry line-of-sight (LOS) sensor (or other type of energy-hungry sensor), and the second module or algorithm is a cost map module that provides a map of cost values, that can be used by a navigation planner or other relevant service in the autonomous device. In some embodiments, the sensor activation module can be understood as changing a sampling rate of the further sensor (and can be referred to as a “sampling rate adapter”). The further sensor (e.g. LOS sensor) may be ‘energy-hungry’ in the sense that it consumes more energy than RF sensing, either or both in terms of the energy required to acquire measurements of RF signals using a RF module, and the energy required to process or analyse those measurements. Alternatively, even if the further sensor does not itself consume more energy than the RF sensing, the activation of the further sensor will increase the energy consumption of the autonomous device, reducing the battery life of the autonomous device.

In the following description, the further sensor is a camera/imaging sensor that can obtain images of the environment in which the autonomous device is located. Thus, the sensor activation module can process the radio sensing input to decide whether or not to use other sensing modalities (i.e. the camera/imaging sensor) at a given time. It will be appreciated that due to the remote sensing capabilities of the radio sensing, the cost value of certain areas in the cost map can be updated even if the autonomous device does not have line-of-sight to that area.

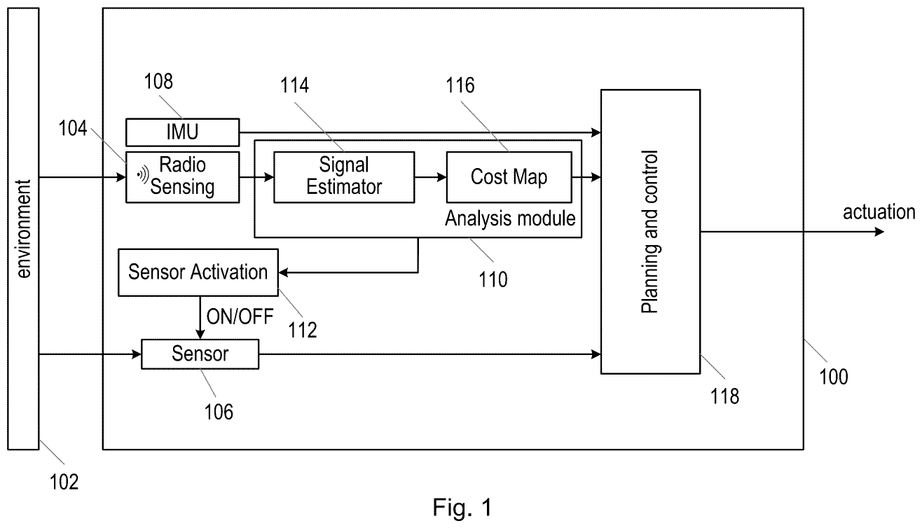

The sensor activation module and cost map module can enable the navigation of the autonomous device to consume less energy compared to a device where all of the environment-sensing sensors are active all the time. In addition, in the case where the autonomous device is able to move itself through the environment, these modules enable the device to be more proactive in avoiding areas with obstacles. The sampling rate adapter and the cost map modules can use an estimation of the radio signal at a given location. Many different technologies can be used to provide such estimation, but some brief details are provided below. In some embodiments, the signal estimation can be provided by a machine learning (ML) model, and some details are provided about how data can be collected to build the estimator dynamically. This model can be implemented by a signal estimator block as shown in FIG. 1 below. Details are provided below about the collection of training data, the training of the model, and how to use the model to adapt the sampling rate of further sensors and detect occluded obstacles.

FIG. 1 shows a device 100 according to embodiments of the techniques described herein, with different functions, algorithms and/or modules of the device 100 being shown as respective blocks. The device 100 can be any form of autonomous device, including those that can move within their environment, such as a vehicle, UAV, robot, etc., or those that do not have autonomous movement capability, but that can selectively monitor different parts of their environment.

In FIG. 1, the environment around the device 100 is represented by block 102, and the environment 102 can be sensed by RF sensing components 104 (e.g. RF receiver circuitry) and selectively sensed by one or more further sensors 106. The environment may be one or more rooms of a building in which the device 100 is located, an outside urban area, an outside rural area, or an area near to an object of interest, such as a base station site, or any combination thereof. The device 100 can optionally also include one or more movement sensors 108 for measuring the movement and/or orientation of the device 100. In FIG. 1 the one or more movement sensors 108 are in the form of an Inertial Measurement Unit (IMU). The orientation of the device 100 can be represented by an angle indicating the direction in which the device 100 is facing, which can be measured in a plane parallel to the ground with respect to a predefined direction or heading, e.g. North, and one or more angles representing the tilt and/or elevation of the device 100 with respect to gravity.

In FIG. 1, one further sensor 106 is shown, and in some embodiments, the further sensor 106 is a camera (imaging module). In some embodiments, more than one further sensor 106 can be provided in the device 106. Other/alternative types of further sensors 106 that can be used include a LIDAR (Laser Imaging Detection and Ranging) sensor, a Radar sensor and an ultrasound sensor.

The sensed RF signals are provided by the radio sensing module 104 to an analysis module 110. The analysis module 110 can process the RF signals, and in conjunction with sensor activation module 112, determine whether the further sensor 106 should be activated to further sense the environment. The analysis block 110 can comprise a signal estimator 114, and optionally also a cost map module 116 that receives the output of the signal estimator 114 and provides a map of cost values that can be used by a navigation planner or other relevant service in the device 100. In particular, the output of the cost map module 116, any signals/measurements (e.g. images) acquired by the further sensor (e.g. camera) 106 following activation, and any measurements from the Inertial Measurement Unit (IMU) 108 (if present in the device 100), can be provided to a planning and control module 118, that can process the input information to determine where the device 100 should move to (in the case where the device 100 is able to move autonomously).

In a first step of the techniques described herein, an internal RF signal map of the radio signals in the environment can be constructed. This map represents the RF signals expected to occur at one or more locations in the environment and enables subsequent RF signals received from the environment to be evaluated. The map is also referred to as an “RF signal map” or “radio signal map” herein. The map can be constructed by the device 100, or measurement data can be provided to a remote server which will perform the map construction and send the resulting map back to the device 100. The radio signal at a given location can be represented by the radio signal strength, or by a richer representation such as an impulse response, a channel transfer function, or an amplitude function. In the context of an autonomous device 100 that can move itself through the environment, it can also be useful to input information on the orientation of the device 100 as the received radio signals can differ with the orientation of the device 100 (e.g. an RF signal may be perceived by the device 100 to be stronger if the device 100 is facing the transmitter of that signal compared to when the device 100 is facing away from the source of the signal). In some embodiments, the map can provide an estimate of the RF signal at different locations and in different orientations of the device 100 at those locations (the location and orientation of the device 100 is also referred to as the “pose” of the device 100). In the following, unless expressly indicated, it will be appreciated that any of the maps derived according to the techniques described herein can take into account different orientations of the device 100 at each location.

In a simple embodiment, the map can comprise radio signal strength at locations defined by the map resolution. The radio signal at these locations can be estimated through, for example, simulation given fixed access points or fingerprinting (as described in Reference [1]). Those skilled in the art will appreciate that the RF signal estimates can be determined using other techniques.

With fingerprinting, multi-sensor fusion is useful to obtain a more accurate representation of the signal map. For example, the IMU 108 (if present), further sensor(s) 106, e.g. camera(s), LIDAR or any other sensors in the device 100 can all or partially be activated and collaboratively provide measurements at each map location (e.g. each grid location, each landmark, or each location of any other type of topology). Multiple passes (i.e. several measurement instances) may be required to provide sufficient statistics for the signals, with those signals being represented as a distribution for each location. One possibility to make the map more compact is to represent the signal by a parametric distribution at each point (location). In this case, only the distribution parameters need to be stored after the construction of the signal map, for instance, the mean and variance of a normal distribution, leading the map to be a two-dimensional (2D) Gaussian process (or three-dimensional (3D) if orientation of the device 100 is included).

The internal signal map can be updated during the normal operation of the device 100 or renewed completely should the environment undergo significant changes.

Although the techniques in Reference [1] focus on Gaussian processes to represent the signal map, it will be appreciated that any suitable type of mapping function can be used. Since the end use of the map in this disclosure can require variations in the map to be estimated, encoded representations of the radio signal map can also be advantageous. Some exemplary types of encoded representations are set out below:
One type of encoded representation is a look-up table. In the case of a look-up table, a loss function can set the look-up table entry at a given location to be the average radio (e.g. Wi-Fi) signal observed at that location. A look-up table requires the space of possible locations in the environment to be discretised. In its simplest implementation, the look-up table can store values for each discrete location. To increase the resolution of the look-up table, interpolation could be used on look-up table entries to determine values for locations where signal measurements are not directly available. In embodiments where RF signal measurements are available when the device 100 is in different orientations, the look-up table can include entries for different combinations of orientation and location.
Another type of encoded representation is a regression model. A parametric model (e.g. a neural network) can map the location (or location and orientation) of device 100 to the radio (e.g. Wi-Fi) signal in that location (or location and orientation), and the loss function can be the mean squared error (MSE) of the model output and the observed location (or location and orientation). The model can be updated using gradient descent. This type of model can be more compact than the look-up table example above.
Another type of encoded representation is an autoencoder. The autoencoder model can output a compressed representation of the radio (e.g. Wi-Fi) signal at that location (or location and orientation), and the loss function can be the mean squared error of the encoded location (or location and orientation) and the decoded radio (e.g. Wi-Fi) signal with the ground truth. The decoder part will not be used at inference time. The autoencoder might perform better than the regression model for the type of anomaly detection task performed by the sensor activation module/sampling rate adapter 112, as described in the next step.
Another type of encoded representation is a combination of a look-up table and an autoencoder. Here, the look-up table records the radio (e.g. Wi-Fi) signals of reference points with the highest levels of confidence (i.e. the reference points with the lowest variances in measurement). Such points may lie close to a wall or a fixture in the environment, or next to an access point, and thus it is less likely to be affected by disturbance. The reference points can be used as additional input features to the autoencoder and aid the model to interpolate areas where disturbances are likely to occur. The look-up table can be updated over time. At training time, the model can learn to predict the radio (e.g. Wi-Fi) signal at the locations (or locations and orientations) not covered by the look-up table, e.g. its relative position to the reference points. The training can be enabled by the ground truth measured at the location (or location and orientation). At inference time, by comparing the model prediction at the location (or location and orientation) and the actual measurement, anomalies can be detected, and the sensor activation module/sampling rate adapter 112 triggered given the threshold.
Yet another type of encoded representation is based on Gaussian processes, as known in the art. Autonomous localisation algorithms using radio (e.g. Wi-Fi) signals rely on modelling the radio signal strength in the environment using a Gaussian process. A similar approach could be used here.

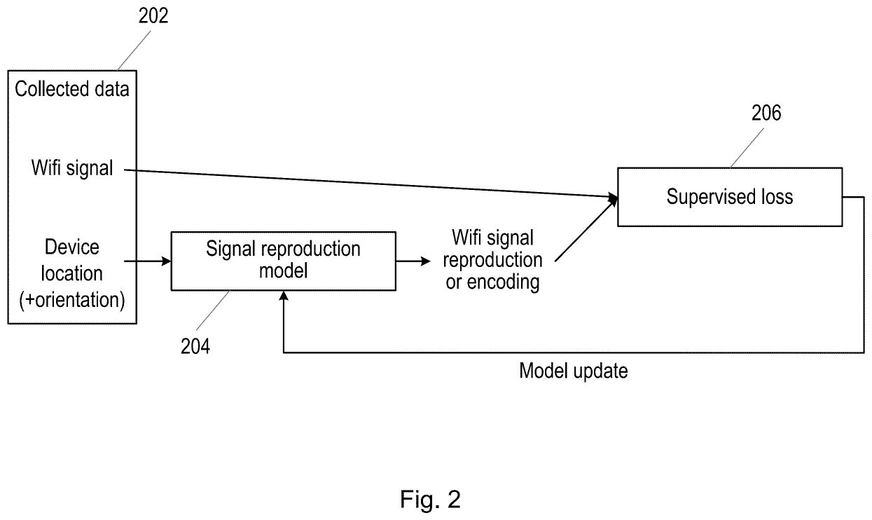

FIG. 2 is a block diagram illustrating the collected data and training procedure of a machine learning (ML) model that provides or is an encoded representation of a RF signal map. In particular, collected data 202 can include RF signal measurements (e.g. Wi-Fi signal measurements) and information on the location of the device 100 corresponding to those RF signal measurements (and optionally also the orientation of the device 100 when those RF signal measurements were obtained). The information on the location (and optionally the orientation) are provided to a signal reproduction ML model 204 (the RF signal map) that estimates the RF signals at that location/orientation. The estimate of the RF signals (or an encoding thereof) is provided to a supervised loss module 206, along with the collected RF signal measurements. The supervised loss module 206 determines a loss function for the ML model 204 compared to the measured RF signals and the loss function is used to update/train the signal reproduction ML model 204.

Thus, at the end of the first step, there is a RF signal map (which can be in the form of a trained ML model) which receives a location and optionally also an orientation of the device 100 as an input, and that outputs an estimation of the RF signals in that location/orientation or an encoded representation of the RF signals. The output can be a running average with standard deviation built incrementally during the collection of the data 202, a Gaussian distribution, or some learned representation.

In a second step, the device 100 is equipped to perform radio signal sensing of the environment. Two types of sensing are considered: mono-static and multi-static, although mono-static sensing may be less accurate and more energy-hungry than the multi-static alternative, e.g. as described in “Multistatic Scatter Radio Network Sensors” by Panos N. Alevizos (https://arxiv.org/pdf/1706.03091.pdf) [Reference 6]. The presence of an object or obstacle, such as a human, in the environment affects the propagation of the signals.

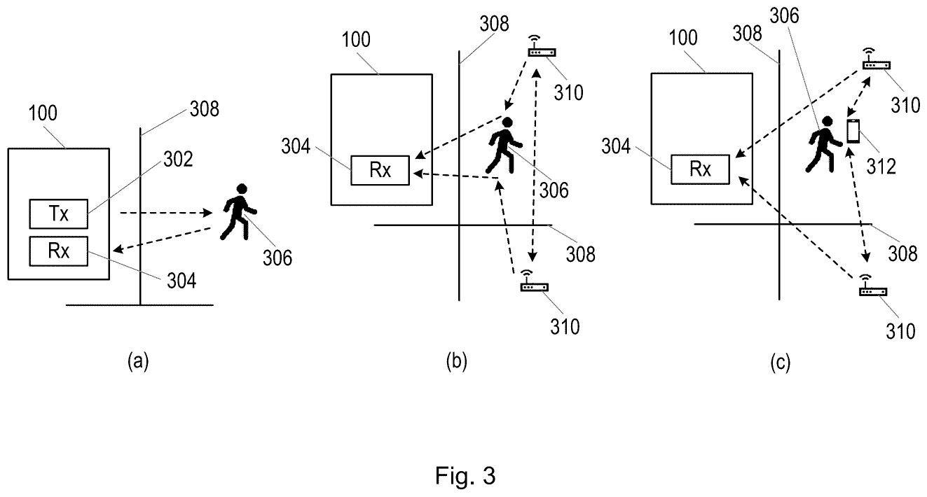

FIGS. 3(a), (b) and (c) illustrate mono-static and multi-static sensing. FIG. 3(a) shows a mono-static case, where the device 100 is equipped with both a transmitter 302 and a receiver 304. The device 100 is able to detect obstacles 306 (in this example the obstacle 306 is a person) through walls 308—depending on the frequency of RF signals used, in a similar way as radar measurements.

In the multi-static case, which is illustrated in FIG. 3(b), the device 100 comprises at least a receiver 304, and receives RF signals from one or more access points 310. The access points 310 may form a mesh to improve the detection accuracy. An obstacle 306 present in a room (defined by walls 308) will perturb the signal on its path from one access point 310 to another, or from one access point 310 to the device 100. By analysing the signal response for all the paths in the network formed by the access points 310 and the device 100, the presence of the obstacle 306 can be estimated, and even the location of the obstacle 306 can be estimated if sufficient access points 310 are participating in the sensing. Passive coherent location (PCL) is one such system that can be deployed to detect and track objects/obstacles.

A third alternative, which is illustrated in FIG. 3(c), considers the situation where the obstacle 306 in the environment is equipped with or has a connected device 312, such as a smartphone. In this case the connected device 312 would also act as a transmitter and receiver in the mesh network instead of merely as an obstacle 306 reflecting and scattering the signal, and the sensing of the obstacle 306/environment can be more accurate.

After the sensing step, the device 100 has access to two types of information. The first is the RF signal response at the location of the device 100, as measured by the receiver 304, and the second is information about the presence of an obstacle 306 in the environment. The information about the presence of an obstacle 306 can be computed in a central server and communicated back to the device 100, or estimated in the device 100 if sufficient computation power is available. However, since an aim of the techniques described herein is to make navigation more energy efficient, the first option of outsourcing the processing to a central server can be preferred.

In a third step, a cost map for mission (task) planning can be calculated. The role of the cost map is to inform the routing and planning algorithms 118 of the device 100 of risky areas in the environment where the device 100 should pay extra attention to (i.e. by activating one or more further sensors 106 to sense the environment, or visiting the area more often) or areas the device 100 should avoid in order not to disturb human activities. High cost areas can be identified as areas where the environment is estimated to be different than what the device 100 would expect from the RF signal map. The cost map can be used for different purposes, in certain tasks, the device 100 should avoid the high cost areas. For example, a cleaning robot might want to avoid areas occupied by humans, and a UAV would avoid areas with new obstacles as it would require analysis of the obstacles with its camera. In that case, the high cost is not necessarily caused by a risk for the device 100, but rather to avoid disturbing the humans in the room. In other cases, such as surveillance and monitoring, the device 100 may be explicitly required to visit these high cost areas. In this latter case, the sign of the cost function can be inverted. It will be noted that when the device 100 is routed into an area with unexpected radio signals, the sampling rate adapter 112 will also turn on, thus automatically activating the further sensor (e.g. camera) 106 to monitor the area without extra specification.

In this third step the computation of a cost function that maps a position in the map (2D or 3D depending on the application) to a value. The cost function can be rule-based, a look-up table, a parametric function or a machine learning model trained to map/update the cost value based on the presence of an obstacle 306 at a given location. Radio signal measurements are used to assess the cost of an area.

Areas where humans or new obstacles are present can provide RF signal measurements that are different from the ones expected according to the RF signal map. The locations identified where these new obstacles are present can be updated with higher costs in the cost map.

As a result of the second step, the radio sensing will inform the device 100 of the presence of an unexpected obstacle 306 that is disturbing the signal. Depending on the accuracy of the sensing, the device 100 can be informed about a certain room containing an obstacle 306, or a more restricted area. In some cases, the sensing algorithm can also provide confidence intervals about the detection. The second (sensing) step can inform the device 100 about multiple targets as well, especially in the case where a mesh network is available.

The cost map can be initialised before the deployment of the device 100 by assigning high costs to locations with known obstacles 306 and low or no cost to free spaces. If no knowledge about the static obstacles 306 is available, then the fingerprinting technique explained above in the first step can also be used to initialise the cost map. As the device 100 navigates and performs radio sensing, the cost map can be updated for each obstacle detected by the sensing step as follows:
if an obstacle is detected in a room, the cost of all the positions in that room can be increased,
if an obstacle is detected in a room before but is not detected any longer, then the cost can be decreased,
if a confidence interval around the location of the obstacle is provided, the cost associated to position the device 100 in this location can be increased proportionally to the confidence of the detection.

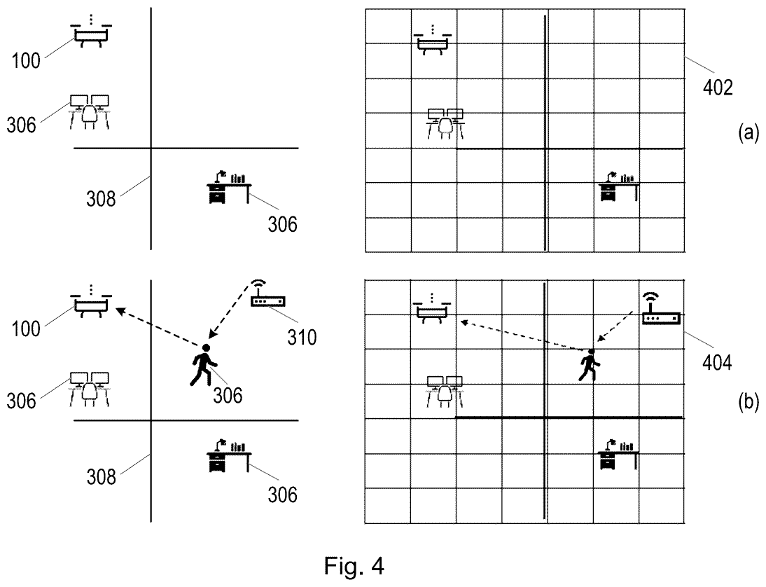

FIGS. 4(a) and (b) illustrate the updating of a cost map after RF signal sensing of an obstacle in an adjacent room. In particular, FIG. 4(a) shows an initial cost map 402 for the illustrated environment that includes certain obstacles 306 and walls 308 known at that time. FIG. 4(b) shows an updated cost map 404 after the new obstacle (person 306) has been detected. In this scenario, due to the task/mission of the device 100, the device 100 can try to avoid the room in which the person 306 is located.

As the device 100 moves, and/or over time, the cost map can be updated and accessed by the planning algorithm 118 controlling the device 100. Many planning and routing algorithms 118 accept this type of cost map as an input to decide the trajectory (route) of an autonomous device 100 using, e.g., reinforcement learning, A*, or optimal control methods. The cost map can be stored as a look-up table, a parametric function (e.g. as potential fields), or a machine learning model that can be updated dynamically. After each update of the cost map, the planning algorithm 118 may compute a new plan (route).

In a fourth step, further energy-hungry sensors (e.g. a camera, LIDAR sensor, etc.) can be activated or deactivated. The role of the activation module 112 is to limit the use of energy-hungry sensors 106 to times when it is really needed. In particular, these times can be when the environment is sensed to be different from what the device 100 expects from a signal map. The internal signal map of the radio signal constructed in the first step can be used to assist navigation. The device 100 can compare the measured radio signal obtained in the second step against the statistics of the internal signal map at its current location (and optionally orientation). The device 100 can then rely on simple threshold-based decision making. For example, if the signals are close, the sampling rate of the further sensor 106 can be lowered (i.e. the further sensor 106 can be switched off more often or for longer) or stay low if it is already at the lowest setting, whereas if the signals are too different the sampling rate of the further sensor 106 can be increased. Depending on the model used, several types of logic can be implemented to increase or decrease the rate of use of the energy-hungry sensor 106. For example, there can be a threshold on the mean squared error between the measured RF signal and expected RF signal, or a threshold on the mean squared error between the encodings of the measured RF signal and expected RF signal. The threshold can be a hyperparameter of the algorithm described herein.

The cost map (determined in the third step), can also be used to assist the sampling rate adaptation block 112 using a simple threshold mechanism. For instance, the further sensor 106 can be turned on before the device 100 enters any high/higher risk areas.

While in the above embodiments the device 100 is considered to be an autonomous device that can move itself through an environment, in some embodiments the device 100 can be a static monitoring platform, i.e. a device 100 that is not able to move itself, but that is able to selectively monitor different parts of the environment. Thus, the device 100 can be a fixed monitoring platform equipped with multiple further sensors/cameras and radio sensors. The radio sensors could monitor the environment, and when a change in the environment is detected, the camera could turn on automatically. In this embodiment, there is no navigation, but the cost map can still be used if some actuation of the RF sensors and/or further sensors is possible. Thus, the cost map could be used to adjust a network of cameras so that they point towards one or more relevant areas, for example.

The above embodiments relate to the measurement and prediction of a RF signal at a given time, without considering any dynamic changes in the RF signals over time. The above techniques can be expanded to accommodate measurements extended in time, and to detect changes as a variation in a time series. The model can still predict the expected static RF signal at a given time, but when used in the sampling rate adapter 112 or for building the cost map, an extra step of time series processing can be included to detect that a noticeable change occurred in the environment.

In some embodiments, the techniques described herein can be applied to devices 100 that are operating in a collaborative setting. For example, in the case where several devices 100 are navigating in the same environment, they can collaborate on one or both of the following tasks: data collection and model training of the expected signal map (which can be done in a fully collaborative and decentralised way using, for example, federated learning); and the sharing of a shared map of the environment (since multiple devices 100 can sense the RF signal at multiple places at the same time, so the cost map can be shared and will contain more information than from just using the input from a single device 100). In addition, in a collaborative setting, the devices 100 could perform multi-static sensing by communicating with each other and improving the accuracy of the detection.

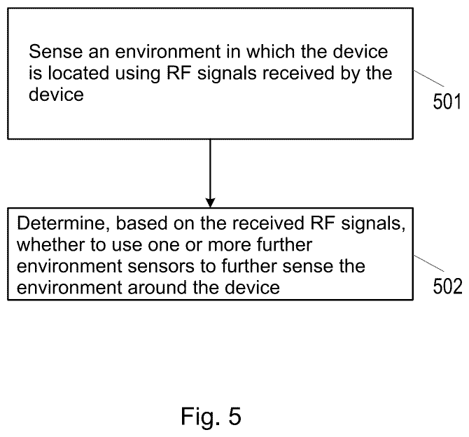

FIG. 5 is a flow chart illustrating a method of controlling a device 100 according to various embodiments. The method can be performed by an apparatus, where the apparatus can be the device 100 itself, or be part of the device 100, or it can be separate from the device 100 (for example the apparatus can be a server that is remote from the device 100. The device 100 may be a device 100 with autonomous movement capability. The apparatus may perform the method in response to executing suitably formulated computer readable code. The computer readable code may be embodied or stored on a computer readable medium, such as a memory chip, optical disc, or other storage medium. The computer readable medium may be part of a computer program product.

In step 501, an environment in which the device 100 is located is sensed using RF signals received by the device 100. Step 501 can comprise processing the RF signals to sense the environment 102. In some embodiments, step 501 can additionally comprise receiving the RF signals using an RF sensor (e.g. radio sensing module 104), and optionally transmitting RF signals using the RF sensor.

In step 502, the apparatus determines, based on the received RF signals, whether the device 100 should use one or more further environment sensors 106 to further sense the environment 102 around the device 100.

In some embodiments, the further environment sensor(s) 106 have a higher energy consumption than the RF sensor 104 in the device 100 that is used to receive the RF signals.

In some embodiments, the further environment sensor(s) 106 comprise any one or more of: a camera sensor, a LIDAR sensor, a Radar sensor, and an ultrasound sensor.

In some embodiments, if the further environment sensor(s) 106 are to be used to further sense the environment 102 around the device 100, the method can further comprise enabling the further environment sensor(s) 106 to sense the environment 102.

In some embodiments, step 502 comprises determining to use the further environment sensor(s) 106 if the received RF signals indicate that an object of interest in the environment 102 is near to the device 100, or an object of interest is unexpectedly located in the environment 102.

In some embodiments, step 502 comprises determining to use the further environment sensor(s) 106 if the received RF signals deviate from an expected RF signal value.

In alternative embodiments, step 502 can comprise comparing the received RF signals to a RF signal map. The RF signal map is based on expected RF signals at different locations in the environment 102, and the comparison in step 502 comprises comparing the received RF signals to the expected RF signals at a current location of the device 100 in the environment 102. In these embodiments, step 502 can comprise determining to use the further environment sensor(s) 106 to further sense the environment if the received RF signals deviate from the expected RF signals by more than a threshold amount. In some embodiments, the deviation of the received RF signals is determined as one or more of: a mean squared error between the received RF signals and the expected RF signals; and a mean squared error between encodings of the expected RF signals and the received RF signals.

The RF signal map can be in the form of an encoded representation. The encoded representation can be any one of:
a look-up table comprising a plurality of entries indicating expected RF signals at respective locations in the environment 102;
a parametric model that maps locations of the device 100 in the environment 102 to expected RF signals;
an autoencoder that is trained to output a compressed representation of the expected RF signals at a particular location in the environment 102;
a look-up table and autoencoder in which the look-up table comprises a plurality of entries indicating expected RF signals at respective locations in the environment 102 at which a confidence level of the expected RF signal is high, and the autoencoder is trained to predict expected RF signals at other locations in the environment 102; and
a Gaussian representation of the RF signal map in which an expected RF signal is modelled using a Gaussian process.

In some embodiments, the device 100 uses a cost map relating to the environment 102. The cost map indicates a cost to the device 100 of moving into or through different parts of the environment 102, and the cost map is updated based on the received RF signals. In these embodiments, if it is determined to use the further environment sensor(s) 106 to further sense the environment 102, the method can further comprise sensing the environment 102 around the device 100 using the further environment sensor(s) 106, and updating the cost map according to the sensing by the further environment sensor(s) 106.

In some embodiments, the method further comprises determining a movement path for the device 100 according to the updated cost map. In these embodiments, the decision in step 502 can be further based on the cost map and the determined movement path for the device 100. Further, in these embodiments, step 502 can comprise determining to use the further environment sensor(s) 106 if the device 100 is to move in to or through a high cost area indicated by the updated map. In these embodiments, step 502 can comprise determining that the further environment sensor(s) 106 are not to be used if the device 100 is to avoid high cost areas indicated by the updated map.

In the above embodiments, the cost map can be any one of:
a look-up table comprising a plurality of entries indicating costs at respective locations in the environment 102;
a parametric model that maps locations of the device 100 in the environment 102 to costs; and
a machine learning model that is trained to update a cost based on a presence of an obstacle at a location in the environment 102.

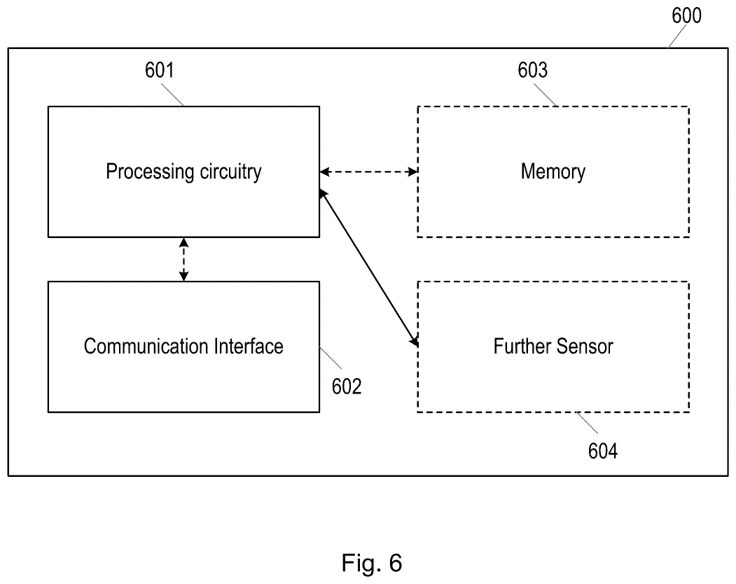

FIG. 6 is a simplified block diagram of an apparatus 600 according to some embodiments that can be used to implement one or more of the techniques described herein. As noted above, the apparatus 600 can be the device 100 itself, be part of the device 100, or it can be separate from the device 100.

The apparatus 600 comprises processing circuitry (or logic) 601. It will be appreciated that the apparatus 600 may comprise one or more virtual machines running different software and/or processes. The apparatus 600 may therefore comprise, or be implemented in or as one or more servers, switches and/or storage devices and/or may comprise cloud computing infrastructure that runs the software and/or processes.

The processing circuitry 601 controls the operation of the apparatus 600 to implement the methods described herein. The processing circuitry 601 can comprise one or more processors, processing units, multi-core processors or modules that are configured or programmed to control the apparatus 600 in the manner described herein. In particular implementations, the processing circuitry 601 can comprise a plurality of software and/or hardware modules that are each configured to perform, or are for performing, individual or multiple steps of the method described herein in relation to the apparatus 600.

The apparatus 600 also comprises a communications interface 602. The communications interface 602 is for use in enabling communications with other nodes, apparatus, computers, servers, etc. For example, the communications interface 602 can be configured to transmit to and/or receive from other apparatus or nodes requests, acknowledgements, information, data, signals, or similar. The communications interface 602 can use any suitable communication technology. In embodiments where the apparatus 600 is separate from the device 100, the communications interface 602 can be used to receive measurements or representations of the RF signals received by the device 100. In embodiments where the apparatus 600 is the device 100 or is part of the device 100, the communications interface 602 can be used to receive the RF signals from the environment. In these embodiments, the communications interface 602 can be, or include, RF receiver circuitry. In these embodiments, the communications interface 602 may be able to transmit RF signals into the environment (for example as in the monostatic implementations described above).

The processing circuitry 601 may be configured to control the communications interface 602 to transmit to and/or receive from other apparatus or devices, etc. requests, acknowledgements, information, data, signals, or similar, according to the methods described herein.

The apparatus 600 may comprise a memory 603. In some embodiments, the memory 603 can be configured to store program code that can be executed by the processing circuitry 601 to perform the method described herein in relation to the apparatus 600. Alternatively or in addition, the memory 603 can be configured to store any requests, acknowledgements, information, data, signals, or similar that are described herein. The processing circuitry 601 may be configured to control the memory 603 to store such information therein.

In embodiments where the apparatus 600 is the device 100 or is part of the device 100, the apparatus 600 can further comprise the one or more further environment sensors 604 that can be selectively activated according to the sensed environment/received RF signals. The further environment sensors 604 may comprise any one or more of a camera/imaging sensor, LIDAR sensor, Radar sensor, and an ultrasound sensor. The further environment sensor(s) 604 can be selectively activated/deactivated under the control of the processing circuitry 601.

Although the apparatus and/or devices may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A computer-implemented method of controlling a device, the method comprising:
sensing an environment in which the device is located using radio frequency, RF, signals received by the device; and
determining, based on the received RF signals, whether to use one or more further environment sensors to further sense the environment around the device.

2. A method as claimed in claim 1, wherein the one or more further environment sensors have a higher energy consumption than an RF sensor in the device that is used to receive the RF signals.

3. A method as claimed in claim 1, wherein the one or more further environment sensors comprise any of: a camera sensor, a Laser Imaging Detection and Ranging, LIDAR, sensor, a Radar sensor, and an ultrasound sensor.

4. A method as claimed in claim 1, wherein, if it is determined to use the one or more further environment sensors to further sense the environment around the device, the method further comprises:
enabling the one or more further environment sensors to sense the environment.

5. A method as claimed in claim 1, wherein the step of determining comprises:
determining to use the one or more further environment sensors to further sense the environment around the device if the received RF signals indicate that an object of interest in the environment is near to the device, or an object of interest is unexpectedly located in the environment.

6. A method as claimed in claim 1, wherein the step of determining comprises:
determining to use the one or more further environment sensors to further sense the environment around the device if the received RF signals deviate from an expected RF signal value.

7. A method as claimed in claim 1, wherein the step of determining comprises:
comparing the received RF signals to a RF signal map, wherein the RF signal map is based on expected RF signals at different locations in the environment, and wherein the comparison comprises comparing the received RF signals to the expected RF signals at a current location of the device in the environment.

8. A method as claimed in claim 7, wherein the step of determining comprises:
determining to use the one or more further environment sensors to further sense the environment if the received RF signals deviate from the expected RF signals by more than a threshold amount.

9. A method as claimed in claim 8, wherein the deviation of the received RF signals is determined as one or more of: a mean squared error between the received RF signals and the expected RF signals; and a mean squared error between encodings of the expected RF signals and the received RF signals.

10. A method as claimed in claim 7, wherein the RF signal map is in the form of an encoded representation, and wherein the encoded representation is any one of:
a look-up table comprising a plurality of entries indicating expected RF signals at respective locations in the environment;
a parametric model that maps locations of the device in the environment to expected RF signals;
an autoencoder that is trained to output a compressed representation of the expected RF signals at a particular location in the environment;
a look-up table and autoencoder in which the look-up table comprises a plurality of entries indicating expected RF signals at respective locations in the environment at which a confidence level of the expected RF signal is high, and wherein the autoencoder is trained to predict expected RF signals at other locations in the environment; and
a Gaussian representation of the RF signal map in which an expected RF signal is modelled using a Gaussian process.

11. A method as claimed in claim 1, wherein the device uses a cost map relating to the environment, wherein the cost map indicates a cost to the device of moving into or through different parts of the environment, and wherein the method further comprises:
updating the cost map based on the received RF signals.

12. A method as claimed in claim 11, wherein if it is determined to use the one or more further environment sensors to further sense the environment around the device, the method further comprises:
sensing the environment around the device using the one or more further environment sensors; and
updating the cost map according to the sensing by the one or more further environment sensors.

13. A method as claimed in claim 11, wherein the method further comprises:
determining a movement path for the device according to the updated cost map.

14. A method as claimed in claim 13, wherein the step of determining whether to use one or more further environment sensors to further sense the environment around the device is further based on the cost map and the determined movement path for the device.

15. A method as claimed in claim 14, wherein the step of determining whether to use one or more further environment sensors comprises determining to use the one or more further environment sensors if the device is to move in to or through a high cost area indicated by the updated map.

16. A method as claimed in claim 14, wherein the step of determining whether to use one or more further environment sensors comprises determining that the one or more further environment sensors are not to be used if the device is to avoid high cost areas indicated by the updated map.

17. A method as claimed in claim 11, wherein the cost map is any one of:
a look-up table comprising a plurality of entries indicating costs at respective locations in the environment;
a parametric model that maps locations of the device in the environment to costs; and
a machine learning model that is trained to update a cost based on a presence of an obstacle at a location in the environment.

18. A method as claimed in claim 1, wherein the device is a device with autonomous movement capability.

19. (canceled)

20. An apparatus configured to control a device, the apparatus configured to:
sense an environment in which the device is located using radio frequency, RF, signals received by the device; and
determine, based on the received RF signals, whether to use one or more further environment sensors to further sense the environment around the device.

21. An apparatus as claimed in claim 20, wherein the one or more further environment sensors have a higher energy consumption than an RF sensor in the device that is used to receive the RF signals.

22.-57. (canceled)
